(19) United States
(12) Patent Application Publication
(10) Pub. No.: US 2004/0096709 A1
(43) Pub. Date: May 20, 2004

(54) Fuel cell system with a dry cathode feed

(76) Inventors: Robert M. Darling, Fairport, NY (US); Mark F. Mathias, Pittsford, NY (US)

Correspondence Address: HARNESS, DICKEY & PIERCE, P.L.C., P.O. BOX 828, BLOOMFIELD HILLS, MI, 48303, US

(21) Appl. No.: 10/295,439

(22) Filed: Nov. 15, 2002

(51) Int. Cl. H01M 8/04

(52) U.S. Cl. 429/13; 429/23

(57) ABSTRACT

A fuel cell system having a dry cathode stream provides moisture control of fuel cell membranes without the need for externally humidified air, thereby reducing the complexity of the system. The stoichiometry of air to the system, and in particular, the membranes of the fuel cells, is adjusted according to current density requirements. The air stoichiometry is increased or decreased according to load requirements. Proper membrane moisture levels are maintained, which results in acceptable proton conductivity levels.

### FIELD OF THE INVENTION

This invention relates generally to fuel cell systems for producing electricity from an electrochemical reaction, and more particularly to controlling the humidification of an electrolyte membrane of such fuel cell systems.

### BACKGROUND OF THE INVENTION

Fuel cell systems typically include a plurality of fuel cells that produce electricity from the conversion of electrochemical energy resulting from the reaction of reducing and oxidizing agents (e.g., hydrogen and an oxidant). Fuel cells have been used as a power source in many applications and can provide improved efficiency, reliability, durability, cost and environmental benefits over other sources of electrical energy. As a result of the improved operation of these fuel cells over other sources of energy, and in particular the reduced emissions (i.e., practically zero harmful emissions), it is very attractive to use electric motors powered by fuel cells to replace internal combustion engines.

One common type of fuel cell is a proton exchange membrane (PEM) fuel cell, which employs a thin polymer membrane that is permeable to protons, but not electrons. The membrane in the PEM fuel cell is part of a membrane electrode assembly (MEA) having an anode on one face of the membrane and a cathode on the opposite face. The membrane is typically made from an ion exchange resin such as a perfluoronated sulfonic acid. The MEA is sandwiched between a pair of electrically conductive elements that serve as current collectors for the anode and cathode, and contain appropriate channels and/or openings for distribution of the gaseous reactants of the fuel cell over the surfaces of the respective anode and cathode catalysts.

In PEM fuel cells, hydrogen (H₂) is the anode reactant (i.e., fuel) and oxygen is the cathode reactant (i.e., oxidant). The oxygen can be either a pure form (i.e., O₂), or air (i.e., a mixture of O₂ and N₂), or O₂ in combination with other gases. The anode and cathode typically comprise finely divided catalytic particles supported on carbon particles, and admixed with a proton conductive resin. The catalytic particles are typically precious metal particles, such as, for example, platinum. Thus, MEAs of this type are relatively expensive to manufacture.

These MEAs also require controlled operating conditions in order to improve operation efficiency and prevent degradation of the membrane and catalysts. These operating conditions include proper water management and humidification. In particular, if a proper moisture level of the electrolyte membrane is not maintained, cell performance is affected (i.e., proton conductivity is reduced and the power produced by the cell drops). Failure to control water levels of the membrane may prevent the membrane from properly conducting hydrogen ions, thereby resulting in a power drop from the fuel cell. For example, if the cell is too dry, protonic conductivity is reduced. Conversely, if excessive liquid water remains in the fuel cell at the cathode, oxygen is unable to penetrate the water remaining and reach the cathode catalyst, thereby also reducing fuel cell performance.

Prior fuel cell systems typically utilize an externally humidified air stream to maintain the proper moisture level of the membranes of the MEAs. Thus, water is continuously supplied to the fuel cell system adding further complexity and cost.

Therefore, it is desirable to provide a fuel cell system that obviates the need for providing pure water from an external source for humidifying the inlet air to the system in order to maintain proper water balance of the MEA. Thus, a less complex system having a dry cathode feed stream is desirable.

A fuel cell system designer must determine the amount of excess reactant gases required to feed to the fuel cell over that needed to support the current that is drawn from the cell. The smaller the amount of excess gas, the greater the system benefit due to improvement in compressor load (air side) and fuel efficiency (fuel side); however, the stack efficiency (i.e., voltage) itself decreases. Thus, the optimum trade-off between the stack and the compressor and fuel efficiencies must be sought.

Typically the decision of how much excess gas to require is driven by the high power design point. This point is typically chosen in a region of the polarization curve where reactant mass-transport limitations start to become significant. In other words, the concentration of reactant gas at the catalyst layer is somewhat depleted relative to the concentration of the gas in the flowfield channels. This occurs because the rate of reactant use is high when the current density is high and the supply of the reactant gas cannot keep up, depleting the reactant gas concentration where the reaction is occurring.

The amount of excess gas fed to the fuel cell can be expressed in various ways. It is often referred to as the utilization; a utilization of 80 percent indicates the percentage of the reactant consumed in the fuel cell to produce electricity. Another common way to refer to this is as the stoichiometry which is 100/utilization; 80 percent utilization corresponds to a stoichiometry of 1.25. In this case, we could also say that 25 percent excess gas is fed to the fuel cell. Modern PEM fuel cells typically are designed to operate at air stoichiometry of 1.5 to 2 and at a fuel stoichiometry of 1.05 to 1.5.

In the prior art, the reactant stoichiometry is applied throughout the current density range or even increased as the current density is lowered. This operating approach and the effects on the average reactant concentration, expressed as mole fraction, both in the flowfield channel and the catalyst layer are shown in FIG. 5. In this example, the reactant is taken to be oxygen with inlet mole fraction (dry basis) of 0.21, and the stoichiometry is constant at 2 (100 percent excess gas) over the current density range. At the stack rating point of 1 A/cm², the reactant mole fraction at the catalyst layer is depleted relative to that in the channel, reflecting mass-transport limitation. As the current density is decreased, the masstransport limitation is relieved and the catalyst layer concentration rises to equal the channel concentration.

### SUMMARY OF THE INVENTION

The present invention provides a fuel cell system having an MEA, which may include, for example, a polymer electrolyte membrane (PEM), that does not require external humidification of the inlet air to maintain proper membrane moisture levels. Control of the humidification level over a broad range of operating levels (e.g., different current densities) is provided without the need for an external pure water source. Under these operating conditions, the cell itself acts as a humidifier for humidifying the air stream. Thus, a proper moisture level is maintained for operation without the need to add external water to the cathode stream.

Accordingly, the present invention provides a fuel cell system that generally reduces the humidification of the air stream by decreasing the stoichiometric flow rate of air fed to the fuel cell as the load requirements for the fuel cell decrease. Thus, performance is improved at low current densities by reducing the water content requirement of the PEM (i.e., less drying force from lower air flow rate), thereby increasing the protonic conductivity of the PEM. Further, by reducing the air stoichiometry in addition to the air flow rate, operation of an air compressor of the system is reduced, thereby increasing the efficiency of the system.

More specifically, the present invention provides a fuel cell for producing electricity from the electrochemical reaction of hydrogen and an oxidant without the need for an externally humidified air stream. The fuel cell system generally includes at least one cell for reacting the hydrogen and the oxidant to produce electricity and a controller for adjusting the air flow rate to the fuel cell based upon the electricity load requirements of the fuel cell.

The electricity load requirements of the fuel cell system include current density requirements and the controller is adapted to decrease the air flow rate when the current density requirement decreases and increases the air flow rate when the current density requirement increases.

The present invention also provides a method for controlling the humidification of an electrolyte membrane within a fuel cell system producing electricity from hydrogen and an oxidant and comprises the step of:

adjusting the stoichiometry of an air supply to the fuel cell system based upon the electricity load requirements of the fuel cell system to thereby control the humidification level of the electrolyte membrane.

The method includes increasing the air stoichiometry upon an increase in a current density of the fuel cell system, and decreasing the air stoichiometry upon a decrease in a current density of the fuel cell system.

Thus, the present invention provides improved performance of a fuel cell operating without an externally humidified air stream. In particular, a fuel cell system constructed according to the principles of the present invention requires no external source of water introduced to the cathode air stream, thereby reducing complexity and increasing reliability of the system.

### BRIEF DESCRIPTION OF THE DRAWINGS

The various features, advantages and other uses of the present invention will become more apparent by referring to the following description and drawings in which:

FIG. 1 is a schematic diagram of a fuel cell system with a dry cathode feed according to the principles of the present invention;

FIG. 2 illustrates a schematic cross-section of a membrane electrode assembly of a fuel cell assembly according to the principles of the present invention;

FIG. 3 is a graph of current density versus cell potential for different stoichiometric air flow rates according to the present invention;

FIG. 4 is a graph of current density versus high-frequency resistance for different air stoichiometric air flow rates according to the present invention;

FIG. 5 is a graph of current density versus reactant stoichiometry and average reactant mole fraction for a constant stoichiometry; and

FIG. 6 is a graph of current density versus reactant stoichiometry and average reactant mole fraction for a variable stoichiometry.

### DETAILED DESCRIPTION OF PREFERRED EMBODIMENTS

The present invention provides a fuel cell system having fuel cells with electrolyte membranes (e.g., PEMs) that operate without an externally humidified air stream (i.e., dry cathode stream). As referred to herein, a “fuel cell system” is an apparatus comprising a fuel cell for providing electricity from an electrochemical process. Further, as referred to herein, a “fuel cell” may be a single cell for the electrochemical creation of electricity (e.g., a single PEM fuel cell) using hydrogen and an oxidant, or a plurality of cells in a stack or other configuration that allows series connection of the cells so as to produce increased voltage.

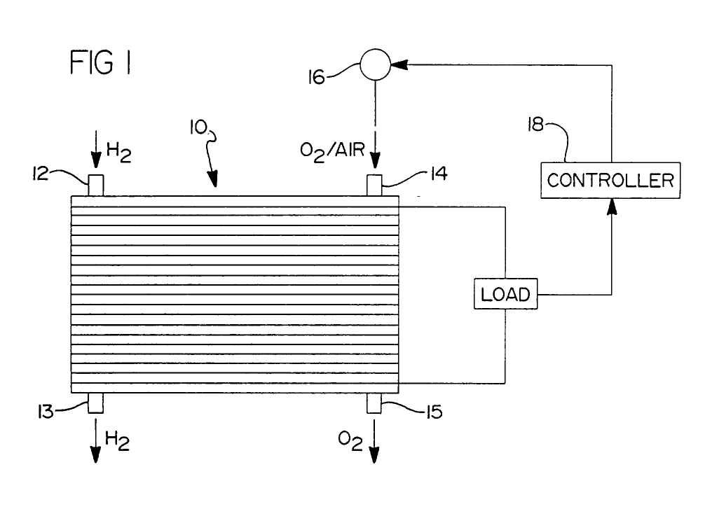

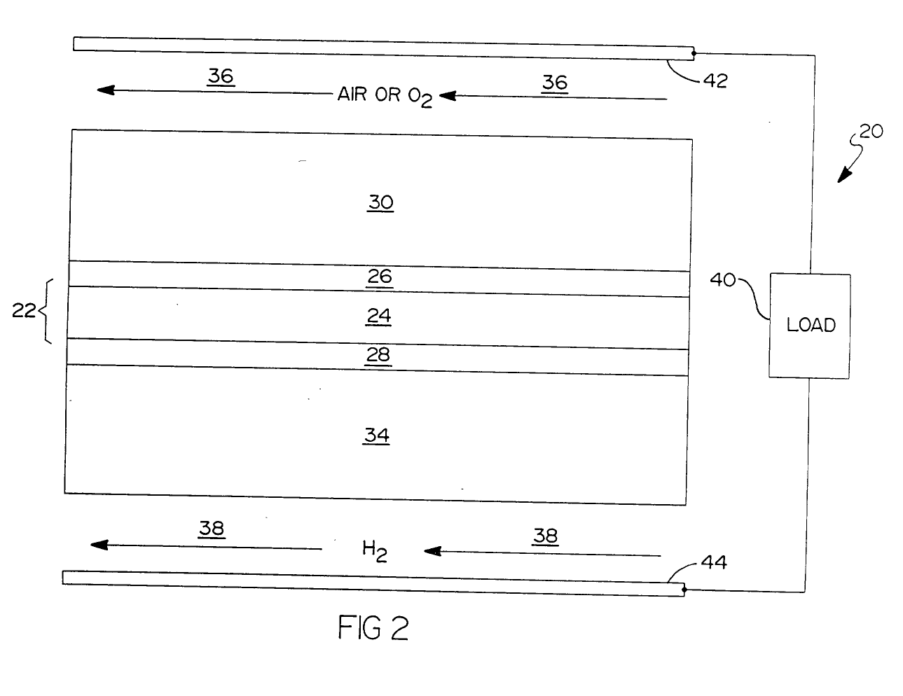

The present invention maintains the proper moisture level of the membranes of the fuel cells without the use of an externally humidified air stream by varying an air stoichiometry to the membranes. This may be further understood with reference to the fuel cell shown and described with respect to FIGS. 1 and 2.

Referring now to FIG. 1, a schematic diagram of a fuel cell stack 10 with a dry cathode feed according to the principles of the present invention is shown. The fuel cell stack 10 is supplied with hydrogen (H₂) (at 12) and oxygen (O₂) (at 14) or air as is known in the art. Exhaust ports 13, 15 for both the fuel and oxidant of the MEAs is also provided for removing hydrogen-depleted anode gas (i.e., anode effluent) from the anode flow field and oxygen-depleted water containing cathode gas (i.e., cathode effluent) from the cathode flow field. Coolant plumbing is provided for supplying and exhausting liquid coolant to the bipolar plates as needed. A variable range compressor (or blower) 16 provides air or oxygen to the fuel cell stack 10. A controller 18 is provided for controlling the operation of the compressor 16 as well as other components of the fuel cell system.

Referring now to FIG. 2, a cross section of a fuel cell assembly 20 that includes a membrane electrode assembly (MEA) 22 is shown. The membrane electrode assembly 22 includes a membrane 24, a cathode 26 and an anode 28. Preferably, the membrane 24 is a proton exchange membrane (PEM). The membrane 24 is sandwiched between the cathode 26 and the anode 28. A cathode diffusion medium 30 is layered adjacent to the cathode 26 opposite the membrane 24. An anode diffusion medium 34 is layered adjacent to the anode 28 opposite the membrane 24. The fuel cell assembly 20 further includes a cathode flow channel 36 and an anode flow channel 38. The cathode flow channel 36 receives and directs oxygen or air (O₂) from the source to the cathode diffusion medium 30. The anode flow channel 38 receives and directs hydrogen (H₂) from a source to the anode diffusion medium 34.

In the fuel cell assembly 20, the membrane 24 is a cation permeable, proton conductive membrane having H⁺ ions as the mobile ion. The fuel gas is hydrogen (H₂) and the oxidant is oxygen or air (O₂). Since hydrogen is used as the fuel gas, the product of the overall cell reaction is water (H₂O). Typically, the water that is produced is rejected at the cathode 26 which is a porous electrode including an electrocatalyst layer on the oxygen side. The water may be collected as it is formed and carried away from the MEA of the fuel cell assembly 20 in any conventional manner.

The cell reaction produces a proton exchange in a direction from the anode diffusion medium 34 towards the cathode diffusion medium 30. In this manner, the fuel cell assembly 20 produces electricity. An electrical load 40 is electrically connected across the MEA 22, a first plate 42 and second plate 44 to receive the electricity. The plates 42 and/or 44 are bipolar plates if a fuel cell is adjacent to respective plate 42 or 44 or end plates if a fuel cell is not adjacent thereto.

To operate efficiently and to produce the maximum amount of electricity, the fuel cell assembly 10 should be properly humidified. In prior art systems, one or both of the air stream supplied to the cathode flow channel and the hydrogen stream supplied to the anode flow channel are humidified by one of several ways known in the art. The most common is the use of a membrane humidifier in which water vapor enters reactant streams via a water-transport membrane (e.g., Nafion). Alternatively, the membrane 24 of the fuel cell can be humidified via use of water wicking materials, as disclosed in U.S. Pat. Nos. 5,935,725 and 5,952,119 which are hereby incorporated by reference, that direct water from a reservoir to the MEA 22.

Alternatively, steam or a mist of water (H₂O) may be injected into both the cathode stream and the anode stream to humidify these streams within the fuel cell stack. In yet another approach, an oxygen stream may be injected in the hydrogen stream of the anode flow channel 38 to react a small amount of H₂ to produce H₂O to humidify the hydrogen stream.

Having described the exemplary fuel cell system 10 adapted for reacting hydrogen and an oxidant to produce electricity, and in which the present invention may be implemented, the present invention includes a method for controlling the stoichiometry of air supplied to the fuel cell system 10. The invention may be implemented as part of, for example, a controller 18 of the fuel cell system 10. The present invention provides for controlling the compressor 16 for supplying air to the fuel cell system 10. In the particular embodiment as depicted in FIG. 1, the controller 18 is programmable to provide control of air flow rate to the fuel cell stack 10 and in particular, the air stoichiometry to the PEMs of the fuel cell stack 10. More specifically, the air flow rate to the cathode of the fuel cell stack 10 is provided at a low stoichiometric flow rate at a low electricity load requirement (i.e., a low current density requirement) of the fuel cell stack 10 and the air flow rate to the cathode of the fuel cell stack 10 is provided at a high stoichiometric flow rate at a high electricity load requirement (i.e., a high current density requirement) of the fuel cell stack 10. The result of this is the average reactant concentration in the channel decreases with load, and the average reactant concentration at the catalyst layer remains constant. By reducing the air flow rate during periods of low load requirements, the humidification requirements for the PEM are reduced. There is a small stack voltage penalty of the lower catalyst layer reactant concentration relative to the constant stoichiometry case. However, the overall advantages in terms of compressor requirements and keeping the stack well humidified, especially with non-fully-humidified feed streams, far outweigh this cost.

For example, a stoichiometric flow rate of 2.0 (i.e., 2.0× the molar flow rate of oxygen reduced in the electrochemical reaction) might be necessary at a current density of 1 A/cm², while a stoichiometric flow rate of only 1.3 might be necessary at a current density of 0.1 A/cm² Depending upon the requirements of the fuel cell system, and in particular, the moisture requirements of the PEMs of the fuel cell stack 10, the air flow rate may be adjusted according to the principles of the present invention. The reduction of the stoichiometric flow rate at low current densities decreases the driving force for drying the membrane, which will result in higher protonic conductivity in the PEM and improved performance. As current density requirements increase, oxygen mass transfer limitations become more critical and it is necessary to operate the fuel cell stack 10 at a higher air stoichiometric flow rate.

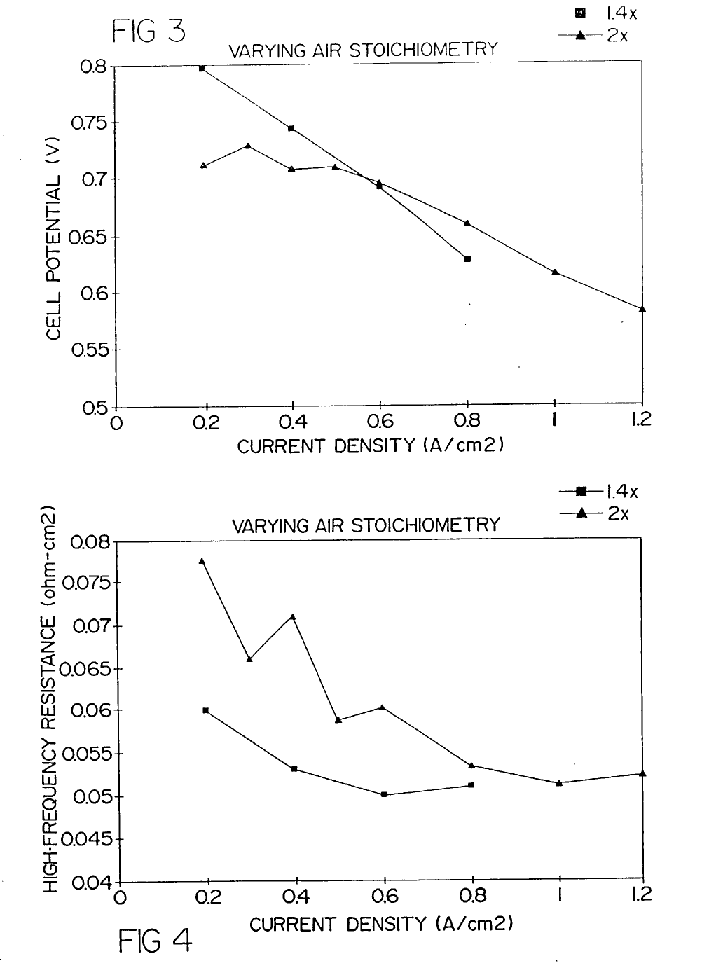

As is shown in FIG. 3, for lower current density requirements, a higher cell voltage can be achieved with a lower stoichiometric flow rate. In addition, as shown in FIG. 4, the high frequency resistance is also lower for the lower stoichiometric flow rate indicating better humidification of the membrane. These figures show the results for a 50 cm² cell operating at 80° C. with an anode dew point of 80° C. and a dry cathode. The anode feed stream contains pure hydrogen at a stoichiometry of 2.0, and the cathode feed stream contains air at either a stoichiometry of 1.4 or 2.0. The inlet pressure of both streams is 150 kPa absolute. It is noted that FIG. 3 shows current density versus cell potential in volts for varying stoichiometries of the present invention, and FIG. 4 shows current density versus high frequency resistance for varying air stoichiometries of the present invention.

The following exemplary equations allow the development of a strategy for decreasing the stoichiometry (decreasing the excess gas) at low current density. These equations were used to generate the plots in FIG. 6. To keep the analysis as simple as possible, gas stream mole fractions are presented on a dry basis. It is also assumed that the streams are fully humidified and that the total pressure is maintained constant independent of current density. Significant deviations from these assumptions do not change the results enough to affect the conclusions of the analysis.

The outlet concentration of a reactant is related to the inlet concentration through the stoichiometry:

$${y}_{out} = {y}_{in} \frac{( S - 1 )}{( S - {y}_{in} )} \qquad ( 1 )$$

where y indicates the reactant (hydrogen or oxygen) mole fraction and S is the reactant stoichiometry. The average cell behavior is related to the average reactant concentration in the flowfield channel. For systems of this nature, where the reaction rates are roughly proportional to the reactant concentrations, a log mean concentration is most representative.

$${\overline{y}}_{channel} = \frac{{y}_{in} - {y}_{out}}{ln ( \frac{{y}_{in}}{{y}_{out}} )} = \frac{( \frac{1 - {y}_{in}}{S - {y}_{in}} ) {y}_{in}}{ln ( \frac{S - {y}_{in}}{S - 1} )} \qquad ( 2 )$$

The mass transport that governs the reactant concentration difference between the channel and the catalyst layer is now considered. The current density is proportional to a mass transfer coefficient for the reactant and the concentration difference driving force for reactant mass transport.

i=kᵢₙₜ(\overline{y}_{channel}−\overline{y}_{catalyst}) (3)

The case of the high-current-density design point (i.e, rating point) is indicated by superscript asterisks.

i*=kᵢₙₜ(\overline{y}^{*}_{channel}−\overline{y}^{*}_{catalyst}) (4)

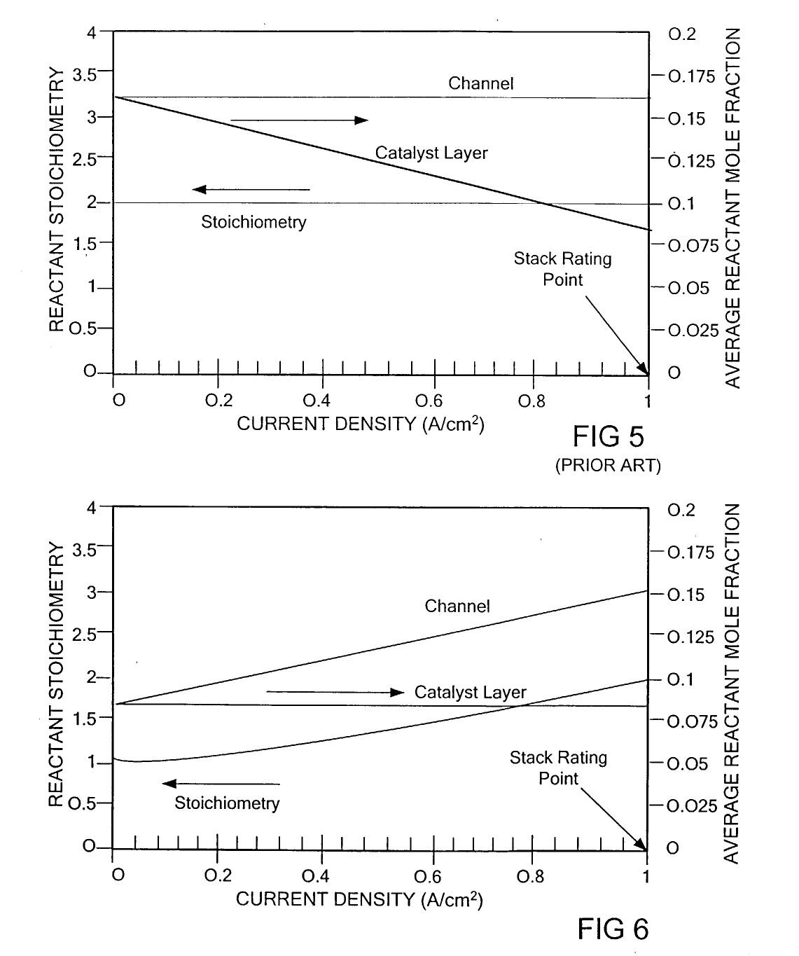

A decrease in the current density while maintaining the stoichiometry causes the mole fraction of reactant gas at the catalyst layer to increase as shown in FIG. 5. However, the present invention adopts the strategy to drop the stoichiometry to keep \overline{y}_{catalyst} constant as the current density is decreased. This approach takes advantage of the relieved mass transport limitation by decreasing stoichiometry. This also has the beneficial effects in that the fuel cell does not have to humidify as much gas, thus diminishing dry out. Using Equations (3) and (4) above, the relationship between current density and the rating current density provides:

$$\begin{matrix}\frac{i}{{i}^{*}} = \frac{\frac{{\overline{y}}_{channel}}{{{\overline{y}}^{*}}_{channel}} - {η}_{transport}^{*}}{1 - {η}_{transport}^{*}} \\ where & ( 5 ) \\ {η}_{transport}^{*} = \frac{{{\overline{y}}^{*}}_{catalyst}}{{{\overline{y}}^{*}}_{channel}} & ( 6 )\end{matrix}$$

This transport efficiency at the rating point reflects the depletion of the reactant at the high current density condition.

FIG. 6 was plotted using Equation (5) with the following parameters: i*=1 A/cm², η*ₜᵣₐₙₛₚₒᵣₜ=0.5, yᵢₙ=0.21.

The controller 18 of the present invention determines the current density (or load requirement) for the fuel cell stack and adjusts the variable range compressor accordingly in order to maintain an optimal air stoichiometry according to the optimization curves such as illustrated in FIGS. 3 and 6. As can be understood by one of ordinary skill in the art, a control schedule can be developed utilizing various air stoichiometry levels that can be graphed out as shown in FIG. 3 and by selecting the air stoichiometry level that provides the highest cell potential for the present current density condition. This reduction of air stoichiometry at low current density decreases the driving force for drying the membrane which leads to improved performance due to a higher protonic conductivity in the membrane and catalyst layers.

Preferably, the various aspects of the operation of the fuel cell system 10 are controlled with the controller 18 that may comprise a microprocessor, micro-controller, personal computer, etc., which has a central processing unit capable of executing a control program and data stored in a memory. For example, the air control strategy of the present invention can be combined with monitoring of high frequency resistance as taught in commonly assigned U.S. Pat. No. 6,376,111 the entirety of which is herein incorporated by reference. The controller 18 may be a dedicated controller specific to any of the components (e.g., to control air-flow), or implemented in software stored in a control module (e.g., a main vehicle electronic control module). Further, although software based control programs are useable for controlling system components in various modes of operation as described herein, it should be understood that the control also can be implemented in part or whole by dedicated electronic circuitry.

The examples and other embodiments described herein are exemplary and not intended to limit the scope of the invention. Equivalent changes, modifications and variations of specific embodiments may be made in accordance with the following claims.

What is claimed is:

1. A method for controlling a moisture level of a fuel cell having an electrolyte membrane for producing electricity from hydrogen and an oxidant, the method comprising the steps of:
detecting a load requirement level for the fuel cell; and
adjusting an air stoichiometry to the fuel cell based upon the detected load requirement of the fuel cell to thereby control the moisture level of the electrolyte membranes.

2. The method according to claim 1 wherein the step of adjusting comprises increasing the air stoichiometry upon an increase in the determined load requirements of the fuel cell.

3. The method according to claim 1 wherein the step of adjusting comprises decreasing the air stoichiometry upon a decrease in the determined load requirements of the fuel cell.

4. The method according to claim 1 wherein the determined load requirements are current density requirements, and the step of adjusting comprises increasing or decreasing the air stoichiometry based upon the current density requirements.

5. The method according to claim 1 further comprising using an air moving device to control the air stoichiometry.

6. The method according to claim 5 further comprising using a controller to control the air moving device.

7. A method of managing the moisture level of a fuel cell having an electrolyte membrane, the method comprising the steps of:
determining a load requirement of the fuel cell; and
varying an air stoichiometry to the electrolyte membrane based upon the determined load requirement.

8. The method according to claim 7 further comprising increasing the air stoichiometry of the electrolyte membrane upon an increase in the determined load requirement.

9. The method according to claim 7 further comprising decreasing the air stoichiometry to the electrolyte membrane upon a decrease in the determined load requirement.

10. The method according to claim 7 further comprising using an air moving device to vary the air stoichiometry.

11. A fuel cell system providing electricity from the electrochemical reaction of hydrogen and an oxidant without requiring an externally humidified air stream, the fuel cell system comprising:
a plurality of fuel cells for reacting the hydrogen and the oxidant to produce electricity; and
a controller for adjusting an air stoichiometry supplied to the plurality of fuel cells based upon load requirements.

12. The fuel cell system according to claim 11 wherein the load requirements are current density requirements and the controller is adapted to decrease the air stoichiometry when the current density requirement decreases.

13. The fuel cell system according to claim 11 wherein the load requirements are current density requirements and the controller is adapted to increase the air stoichiometry when the current density requirement increases.

14. The fuel cell system according to claim 11 further comprising air moving means and wherein the controller is adapted to control an air flow of the air moving means.

15. A fuel cell system adapted for operation with a dry cathode feed to provide electrical power, the fuel cell system comprising:
an anode adapted to accept hydrogen;
a cathode adapted to accept oxygen;
an electrolyte membrane between the anode and cathode; and
an air supply unit configurable to provide different air stoichiometries to the fuel cell system based upon the electrical power requirements of the fuel cell system.

16. The fuel cell system according to claim 15 wherein a load is powered by the fuel cell system and the air supply unit is adapted to increase and decrease the air stoichiometry based upon a load demand of said load.

17. The fuel cell system according to claim 16 wherein the air supply unit is adapted to increase the air stoichiometry upon an increase in a current required by the load.

18. The fuel cell system according to claim 16 wherein the air supply unit moving device is adapted to decrease the air stoichiometry upon a decrease in a current required by the load.

19. The fuel cell system according to claim 15 wherein said air supply unit includes a programmable controller for controlling the air stoichiometry.

20. A fuel cell system for producing electricity from hydrogen and an oxidant, the fuel cell system comprising:
a plurality of fuel cells for reacting the hydrogen and the oxidant to produce electricity;
wherein each of the plurality of fuel cells comprises an anode, a cathode and an electrolyte membrane therebetween; and
an adjustable air supply unit configured to provide a variable air stoichiometry to the plurality of fuel cells based upon load requirements for the plurality of fuel cells.
